SEQUENCE LISTING (1 sequence)

SEQ ID NO: 1 - DNA, 1000 bp, Komagataeibacter xylinus
gtgtagttaagtttttacaatacaagtcgcacgatcttttcgggtttagtggcggacgggtgagtaacgcgtagggatttatccacgggtggggaataattttggaaaactgaagctaatcccgcatgacacctgagggtcaaaggcgcaagtcccctgtggagaaacctgctttcaattacctagttgggggggtaaaggcctaccaaggcaatgatcaatagctggtctgagaggatgatcacccacactgggactgaaacacggcccaaactcctacgggaggcagcagtgggaaatattgaacaatgggcgcaaccctgatccaccaatgccgcgtgtgtgaaaaaggttttcggattgtaaagcattttcagcggggacaatgatgacggtccccgcaaaaaaacccccggctaatttcgtgccagcacccgcggtaatacaaagggggcaagcgttgctcgaaatgactgggcgtaaagggcgcgtaggcggttgacacagtcaaatgtaaaattcccgggtttaacctgggggctgcttttgatacgtggcaactaaagtgtgaaaaagggttgtgaaattcccagtgtagaggtgaaattcgtaaatattggaaaaaacaccgggggcaaaggcggcaacctggctcatgactgaccctgaggcgcaaaagcgtggggagcaaacaggattaaataccctggtagtccacgctgtaaacaatgtgtgctgaatgttgggtgactttgtcattcagtgtcgtatttaacgcgataagcacaccgcctggggagtacggccgcaaggttaaaactcaaagaaattgacgggggcccgcacaagcgggggagcatgtggtttatttcaaagcaacgcgcaaaaccttaccagggcttgacattgggaaggccgtgtccagaaatgggcattttctcgcaaaaaaacctcaaccaacaggtgcctgcatggtttgtctccctctccggtccgggaa

(19) United States
(12) Patent Application Publication
(10) Pub. No.: US 2017/0332624 A1
(43) Pub. Date: Nov. 23, 2017

(54) INSECTICIDAL EFFECT BASED ON A MODIFICATION OF THE BACTERIA OF THE GENUS GLUCONACETOBACTER

(71) Applicant: Miguel Gidekel, Santiago (CL)

(72) Inventor: Miguel Gidekel, Santiago (CL)

(73) Assignee: INVERSIONES, CIENCIA Y TECNOLOGIA SPA, Washington, DC (US)

(21) Appl. No.: 15/289,139

(22) Filed: Oct. 8, 2016

Related U.S. Application Data
(63) Continuation-in-part of application No. 14/120,777, filed on Jun. 26, 2014, now Pat. No. 9,491,950.

(51) Int. Cl. A01N 25/00; B27K 3/00; C12R 1/02; A01N 63/00; C12R 1/00

(52) U.S. Cl. CPC A01N 25/006; C12R 1/02; A01N 63/00; B27K 3/002; C12R 1/00

(57) ABSTRACT

An insecticidal composition wherein the composition has an insecticidal effect based a modification of the bacteria of the genus gluconacetobacter. The Insecticidal effect show activity against Green peach aphid (Myzus persicae (Sulzer)); Western flower thrips (Frankliniella occidentalis) on peaches and Citrus woolly whitefly (Aleurothrixus floccosus) on citrus.

### REFERENCE TO CROSS RELATED APPLICATIONS

This Continuation-In-Part application is based on U.S. Nonprovisional patent application Ser. No. 14/120,777, filed on Jun. 26, 2014, which is incorporated herein in their entirety.

### SEQUENCE LISTING

The instant application contains a Sequence Listing which has been submitted electronically in ASCII format and is hereby incorporated by reference in its entirety. Said ASCII copy, created on Feb. 25, 2016, is named Termites_SL.txt and is 1,672 bytes in size.

### FIELD OF THE INVENTION

The present invention embraces a biological system that can be used as bio-repair, insecticide, termiticide and bio-additive. This invention provides a biomaterial based in a bacteria that produces cellulose from sugar derivate. The biological system increases the resistance and flexural strength and also has an insecticide effect.

### BACKGROUND OF THE INVENTION

Soil termites, also known as subterranean termites, are the most destructive termites in the United States. These insects, and other related insects can cause a lot of damage and should be controlled upon discovery.

Hundreds of thousands of termites in a colony well-organized among workers, soldiers and Queens tunnel 24 hours a day through soil and into the wooden frames of houses, fences and buildings providing new sources of cellulose for the entire colony.

If left untreated, termites can destroy the entire value of a home. According to the National Pest Management Association, termites are costing Americans more than $5 billion in damage each year. This is more than fire and floods combined. Destruction is boundless, because any home, regardless of design, can offer the ideal combination of heat, moisture and food for termites. In addition, many plans for housing are not covered by insurance for such damages. Without insurance protection, serious problems in selling a house may arise. Many lenders require a termite bond before lending money to homebuyers.

### SUMMARY OF THE INVENTION

The present invention provides for the first time a biological system which provides the dual function of killing termites and other wood damaging insects while also producing a by-product substance having the capability of repairing damage by termites and other insects to wood and related cellulosic products.

In a particular embodiment of the present invention, a biological system, toxic to termites, is provided which produces a means by which damage caused by termites is repaired, said means comprising a by-product produced by a modification of the bacteria of the genus Gluconacetobacter. Preferably, the biological system is in the form of toxic bait.

In another embodiment of the present invention, a process is provided for killing termites and other wood damaging insects and for repairing damage to wood and related cellulosic products caused by termites comprising the steps of:
(a) Providing a modification of the bacteria of the genus gluconacetobacter toxic to termites and wood damaging insects, and insects family like acaridae and nematodes
(b) Converting said bacterial modification into a bait attractive to termites and other insects as a source of food;
(c) Allowing said bacterial modification to produce by-product ooze capable of repairing would damage by termites and other wood damaging insects.

The by-product ooze is toxic to termites and other insects and non-toxic to humans.

### BRIEF DESCRIPTION OF THE DRAWINGS

FIG. 1. shows the 16S ribosomal RNA gene sequence of Gluconacetobacter malus.

FIG. 2. illustrates the phylogenetic tree of 16S ribosomal RNA gene sequence of Gluconacetobacter malus with other species with high similarity.

FIG. 3. shows the kinetic coverage of the cellulose adding the bacteria during the time.

FIG. 4. shows the percentage of mortality of Brevipalpus chilensis with water (witness) and treated insect with culture supernatant (SN) of the bacterial cellulose culture. The SN was added to the privet leaves, not directly to the insect. After 7 days of post-treatment, the percentage of mortality was measured. This assay was performed using eggs and mobile insects. Each assay was done 10 times.

FIG. 5. Shows the percentage of mortality of B. chilensis using water (witness), diluted supernatant (diluted SN) and concentrated SN (direct SN of bacterial cellulose culture). The assay was done as in FIG. 3.

FIG. 6. shows the percentage of mortality of B. chilensis using supernatant (SN) of bacterial cellulose culture using different nutrient sources (sugar beet derivates 1 and 2, and glucose) with or without bacteria (treated with 0.1 N NaOH). The assay was done as in FIG. 3.

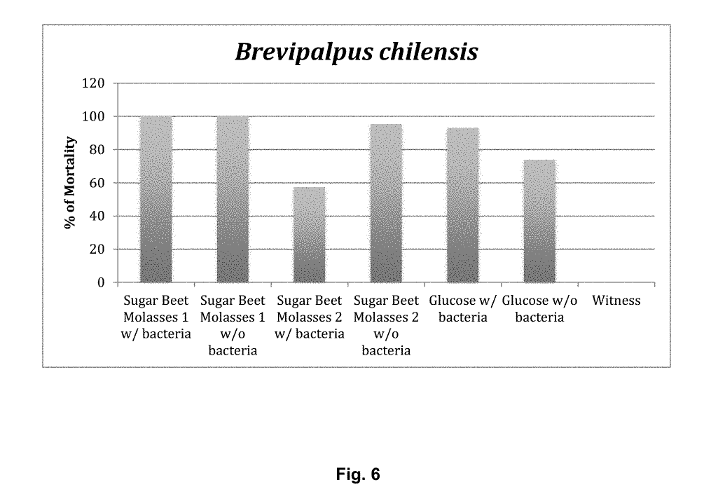

### DETAILED DESCRIPTION OF THE INVENTION

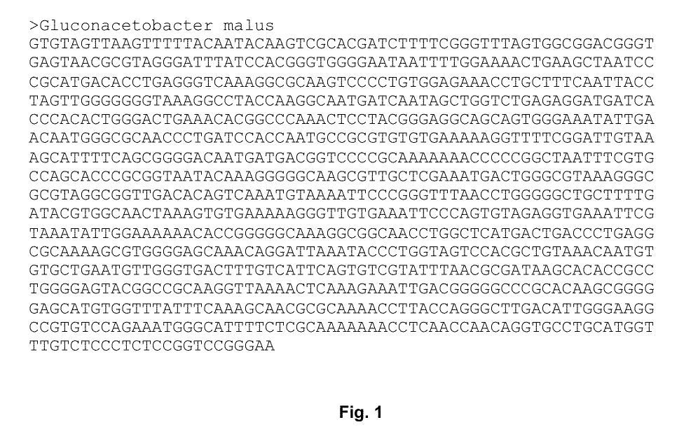

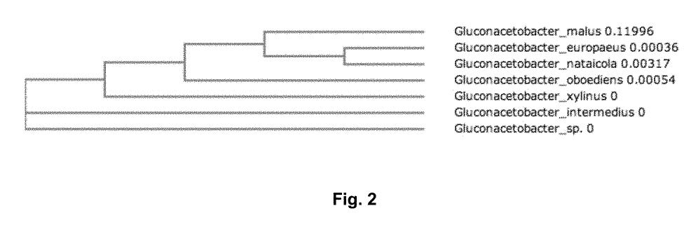

A Gluconacetobacter bacterium from an apple was isolated. First, the apple was washed with distillated water and then it was crashed in 25 mL of sterile distillated water as well. The extract produced was incubated for 10 days at room temperature for the bacteria production. After this incubation, serial dilutions of the culture were done on LB agar plates and were incubated at 27-Celsius degrees for 2 days. The most diluted colonies corresponding to the white colored colonies were selected and analyzed by 16srRNA-PCR procedure using F8 forward primer (AGAGTTTGATCCTGGCTCAG) and R1492 reverse primer (GGTTACCTTGTTACGACTT) (Weisburg et al., 1991; Baker et al., 2003). The sequence obtained (FIG. 1) was analyzed by BLAST and had 92% of identity with Gluconacetobacter intermedius (gi: 594191428), Gluconacetobacter xylinus (gi: 359803333), Gluconacetobacter sp. (gi: 323482039), Gluconacetobacter oboediens (gi: 359803727), Gluconacetobacter europaeus (gi: 380292627) and Gluconacetobacter nataicola (gi: 343200325). So, we called our bacteria strains as Gluconacetobacter malus. Also, a phylogenetic tree analysis using ClustalW2-Phylogeny program was performed (FIG. 2).

An evaluation of cellulose yield was done. G. malus was cultured in liquid mediums using different nutrient sources (glucose and sugar derivate) for 2 weeks at 27 Celsius-degrees without shaking (static culture) to produce cellulose. A cellulose yield of 128.8 g/L, 119 g/L, 111.9 g/L, 99.8 g/L and 94.9 g/L was produced by G. malus. From glucose, sugar beet derivates 1, 2, 3 and 4, respectively (shown in Table 1).

TABLE 1
Cellulose yield using different nutrient sources.

| | Cellulose Yield | Cellulose Yield |
|---|---|---|
| Sugar Source | (gr cellulose/ml culture) | (gr cellulose/L culture) |
| Glucose | 0.13 | 128.8 |
| Sugar Beet Molasses 1 | 0.12 | 119 |
| Sugar Beet Molasses 2 | 0.11 | 111.9 |
| Sugar Beet Molasses 3 | 0.10 | 99.8 |
| Sugar Beet Molasses 4 | 0.09 | 94.9 |

### Example 1

Biological System as Bio-Repair

To test the biological system as bio-repair, physical properties of these celluloses were assayed by doing a Dynamic Mechanic Analysis (DMA). Resistance and mechanical strength of cellulose are five times more in comparison with wood-cellulose.

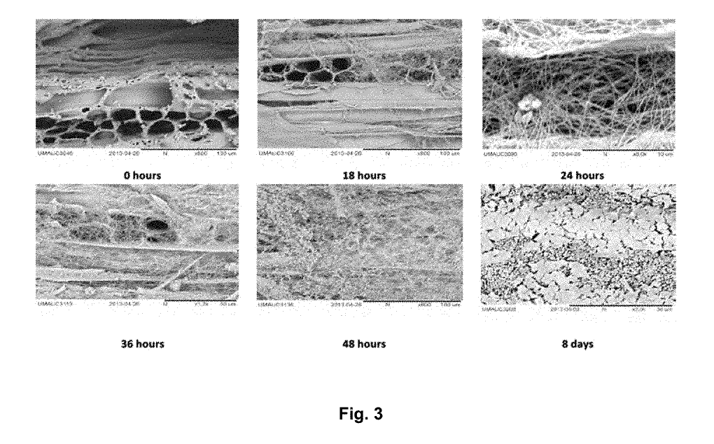

Furthermore, electronic microphotographs shows how this biological system repairs and reconstitutes the damaged wood starting on the initial hours from its application to 8 days (FIG. 3). At 24 hours, a great quantity of cellulose's fibers can be shown. An efficient bio-repair process can be detected from 24 hours up to 8 days.

In USA there are 79,000,000 homes affected by termites. This biological product has a lot of advantages: is not toxic to the human, doesn't damage the environment and is a very effective as bio-repair product. It can be used as bio-repair on damaged wood's structures of homes caused by termites and other insects.

### Example 2

Biological System as Insecticide

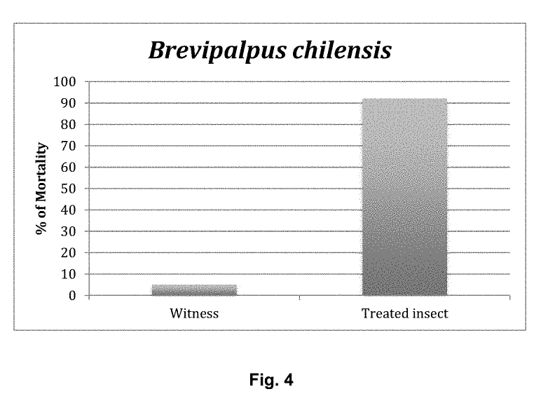

To evaluate the insecticidal effect, an aliquot of the supernatant from bacterial cellulose cultures was settled on a plate with a coleopteran to emulate the natural environmental conditions. When the coleopteran reaches the supernatant, the insect dies. Contrary to when the insect eats the bacterial cellulose. These assays were performed using Brevipalpus chilensis (a mite that infects vine plants). The SN was added to the privet leaves, not directly to the insect. After 7 days of post-treatment, we measured the percentage of mortality. A 92% of mortality was shown using the SN of the bacterial cellulose culture (FIG. 3). Also, the same assay was done, but using a 1/10 dilution of the SN (FIG. 4). We detected a 73% of mortality. So, the diluted SN is very effective.

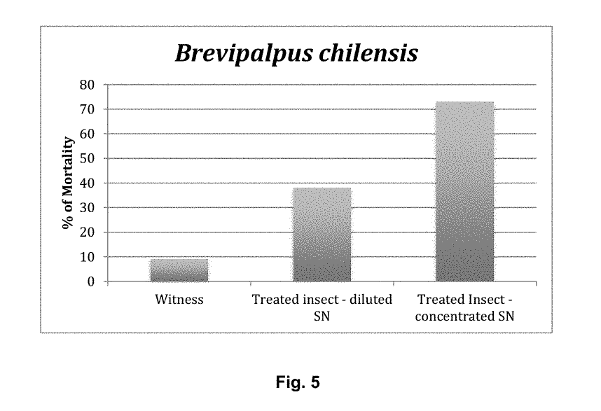

Furthermore, a similar assay was performed using SN from bacterial cellulose cultures with different nutrient source. We determined that the different SNs were effective (FIG. 5). Also, the same treatment was done with and without bacteria (SN with 0.1 N NaOH). We saw activity in both treatments. We conclude that the toxin is in the bacterial cellulose supernatant.

In the vinifera vine sprouting in early may cause tissue necrosis and death cause of outbreaks and also, dehydration rachis, pedicels and bronzing of leaves.

On the other hand, we test the insecticidal effect using 9 nematodes (Table 2). Nematodes-based termite s are phytoparasitic of a wide of vegetable cultivation like tomato and also vine plants. In this assay we use the SN (filtrated or not) of the liquid culture using Sugar Beet Derivate 1 as carbon source. All the insects die using the SN. Water added to the nematodes was used as negative control. The SN is effective against different types of insects.

TABLE 2
Insecticidal effect of Supernatant using
Sugar Beet Molasses as nutrient sources

| Dilution | Filtrated | Not Filtrated | Water |
|---|---|---|---|
| 1 Supernatant/ | 9 nematodes died | 9 nematodes died | 9 nematodes alive |
| 9 nematodes | | | |
| 5 Supernatant/ | 5 nematodes died | 5 nematodes died | 5 nematodes alive |
| 5 nematodes | | | |

This biological product can be used as insecticide, mostly important as a termiticide to protect the wood structures from termites while this product is repairing the damaged wood as mentioned before. Also, can be used in the agriculture, mainly in the countries that are susceptible to insect damage by mites and other insects. This new biological compound shows a great potential to control the damage of Brevipalpus chilensis in our Vitis vinifera. The actually acaricides are not sufficient effective to control this mite.

### Example 3

Biological System as Bio-Additive

The biological compound can be used in the fabrication of added-resistance laminated and agglomerated wood panels. Plywood increases over 5 times its resistance to flexion.

In 2011, the International Agency for Research on Cancer (IARC) classifies the formaldehyde as carcinogenic agent, based on epidemiologic studies of cancer in animals and humans. The new biological compound can replace the formaldehyde to a polymer that catalyzes the dry and reduces the use of matchwood for the Eco-wood formulation, using materials that aren't toxic on humans.

In order to prove the insecticidal effect of the present invention, three different test have been performed to test the insecticidal effect on other insects besides termites. The following disclosure provides addition evidence of the insecticidal nature of the claimed ingredient/process on THREE specific and commercially important insects.

The Green peach aphid (Myzus persicae (Sulzer) and the western flower thrips (Frankliniella occidentalis) are important pest on peaches and nectarines which require regular insecticidal treatments. Thrips feeding causes scarring, principally on nectarine. Additionally, thrips and aphids can transmit viral diseases. Green peach aphid can affect plant growth and kill the plants at high pest densities.

On the other hand, for citrus, the Citrus woolly whitefly (Aleurothrixus floccosus) is a key pest which sucks phloem sap, and when populations are large can cause leaves and fruit to wilt and drop.

In this context the main purpose of this work is to provide data about field insecticidal activity of the experimental formulation EAGLEONE® against key agricultural pest insects.

The study was performed on:
Green peach aphid (Myzus persicae (Sulzer)
Western flower thrips (Frankliniella occidentalis)
Citrus woolly whitefly (Aleurothrixus floccosus)

Materials and Methods

This trial was performed in a commercial orchard, without previous applications of miticides and insecticides on the season. For the study, Prunus persica Carson cultivar and Citrus x sinensis were used. The trial site conditions and orchard's features are shown in Table 1 and Table 2.

The experimental units in this experiment were 8 plants using 4 more untreated as insulation between repetitions. Four replicates were used by treatment, in a completely randomized design.

TABLE 1
First research site features.

| | |
|---|---|
| Application Date | Jan. 4, 2016 |
| Location | Peumo |
| Variety | Prunus persica Carson |
| Plant Densities | 1333 plants per hectare (3 × 2.5 m) |
| Application timing | Preharvest |
| Application Method | Trolley gasoline engine power sprayer 220 L |

TABLE 2
Second research site features.

| | |
|---|---|
| Application Date | Jan. 6, 2016 |
| Location | Peumo |
| Variety | Citrus × sinensis |
| Plant Densities | 400 plant per hectare (5 × 5 m) |
| Application timing | First fruit stage |
| Application Method | Trolley gasoline engine power sprayer 220 L |

### Treatments:

In both cases, four rates of Eagleone®, one control and one untreated treatment were compared (See Table 2).

TABLE 2
Treatments.

| Treatment | Formulation | Active Ingredient | cc- g/hectare |
|---|---|---|---|
| I | Control | water | 100% |
| II | Eagleone ® | experimental extract | 400 |
| III | Eagleone ® | experimental extract | 500 |
| IV | Eagleone ® | experimental extract | 600 |
| V | Eagleone ® | experimental extract | 700 |
| VI | Untreated | — | — |

### Statistical Analysis

The following assessments were performed at 2, 4 and 10 Days after applications (DAA).

The effectiveness of the treatments was determined by counting living insects (nymphs) using a digital optical microscope 40× in laboratory. The samples were taken from 100 infested leaves per replica, establishing the number of living insects. Separation criteria of living individuals from dead were: color, dehydration and lack of movement to the stimulus with a brush.

All of this variables were compared with ANOVA (p=0.05) and multiple comparison Test with Bonferroni correction (0.05/6).

Results

Insecticidal activity of Eagleone® was confirmed against Green peach aphid (Myzus persicae (Sulzer)); Western flower thrips (Frankliniella occidentalis) on peaches and Citrus woolly whitefly (Aleurothrixus floccosus) on citrus. Results obtained suggest that Eagleone® can have some ingest or residual effect, because not only a knock down effect was obtained. It was also possible to establish that a minimum effective dose is 400 cc/ha, because this dose doesn't show significate difference of major dose.
Green peach aphid (Myzus persicae (Sulzer)

TABLE 3
Mean pre and post-treatment score of live aphids
per shoot on 400 shoots per treatment

| | | Mean M. persicae score | | | | | | | |
|---|---|---|---|---|---|---|---|---|---|
| Treat- | | Preappli- | | | | | | | |
| ment | Formulation | cation | | 2 DDA | | 4 DAA | | 10 DAA | |
| I | Control | 13.75 | a | 23 | a | 27.75 | a | 32.75 | a |
| II | Eagleone ® | 13.25 | a | 4.75 | b | 3 | b | 6.75 | b |
| | (400 cc/ha) | | | | | | | | |
| III | Eagleone ® | 12.5 | a | 3.25 | b | 1.25 | b | 5 | b |
| | (500 cc/ha) | | | | | | | | |
| IV | Eagleone ® | 11.5 | a | 4.75 | b | 3.5 | b | 3.25 | b |
| | (600 cc/ha) | | | | | | | | |
| V | Eagleone ® | 11 | a | 5.75 | b | 2.25 | b | 2 | b |
| | (700 cc/ha) | | | | | | | | |
| VI | Untreated | 12.25 | a | 25.25 | a | 31.5 | a | 35.75 | a |

| | | | | |
|---|---|---|---|---|
| F | 0.64 | 97.47 | 229.23 | 166.95 |
| p value | 0.67 | <0.001 | <0.001 | <0.001 |

Means in each column followed by different letters are significantly different (P ≦ 0.05/6)

Western flower thrips (Frankliniella occidentalis)

TABLE 4
Mean pre and post-treatment score of live thrips
per shoot on 400 shoots per treatment

| | | Mean F. occidentalis score | | | | | | | |
|---|---|---|---|---|---|---|---|---|---|
| Treat- | | Preappli- | | | | | | | |
| ment | Formulation | cation | | 2 DDA | | 4 DAA | | 10 DAA | |
| I | Control | 7.5 | a | 15 | a | 17.75 | a | 20 | a |
| II | Eagleone ® | 6.5 | a | 5 | b | 3.75 | b | 3 | c |
| | (400 cc/ha) | | | | | | | | |
| III | Eagleone ® | 7.75 | a | 2.75 | b | 2.25 | b | 1.75 | c |
| | (500 cc/ha) | | | | | | | | |
| IV | Eagleone ® | 7 | a | 1.5 | b | 1 | b | 0.5 | c |
| | (600 cc/ha) | | | | | | | | |
| V | Eagleone ® | 6.5 | a | 2 | b | 1.5 | b | 1 | c |
| | (700 cc/ha) | | | | | | | | |
| VI | Untreated | 7.25 | a | 13.25 | a | 15.5 | a | 17 | b |

| | | | | |
|---|---|---|---|---|
| F | 0.30 | 53.25 | 102.74 | 189.04 |
| p value | 0.908 | <0.001 | <0.001 | <0.001 |

Means in each column followed by different letters are significantly different (P ≦ 0.05/6)

Citrus woolly whitefly (Aleurothrixus floccosus)

TABLE 5
Mean pre and post-treatment score of live whiteflies
per shoot on 400 shoots per treatment

| | | Mean A. floccosus score | | | | | | | |
|---|---|---|---|---|---|---|---|---|---|
| Treat- | | Preappli- | | | | | | | |
| ment | Formulation | cation | | 2 DDA | | 4 DAA | | 10 DAA | |
| I | Control | 30.5 | a | 32.25 | a | 34 | a | 36.5 | a |
| II | Eagleone ® | 29.25 | a | 5.5 | b | 4 | b | 3.5 | b |
| | (400 cc/ha) | | | | | | | | |
| III | Eagleone ® | 28 | a | 5.75 | b | 4.75 | b | 2.75 | b |
| | (500 cc/ha) | | | | | | | | |
| IV | Eagleone ® | 27.25 | a | 5.25 | b | 2.75 | b | 2 | b |
| | (600 cc/ha) | | | | | | | | |
| V | Eagleone ® | 27.5 | a | 5.25 | b | 2.5 | b | 0.75 | b |
| | (700 cc/ha) | | | | | | | | |
| VI | Untreated | 26.75 | a | 29 | a | 31.75 | a | 33 | a |

| | | | | |
|---|---|---|---|---|
| F | 0.71 | 211.4 | 290.9 | 233.5 |
| p value | 0.621 | <0.001 | <0.001 | <0.001 |

It is possible to conclude that Eagleone® at 400 cc/ha can be recommended to control Green peach aphid (Myzus persicae (Sulzer)) and Western flower thrips (Frankliniella occidentalis) on peach trees, and also Citrus woolly whitefly (Aleurothrixus floccosus) on citrus.

What is claimed is:

1. An insecticidal composition wherein the composition has an insecticidal effect based a modification of the bacteria of the genus gluconacetobacter.

2. The insecticidal composition of claim 1, wherein the Insecticidal effect show activity against Green peach aphid (Myzus persicae (Sulzer)); Western flower thrips (Frankliniella occidentalis) on peaches and Citrus woolly whitefly (Aleurothrixus floccosus) on citrus.

3. The insecticidal composition of claim 2, wherein the insecticidal effect includes some ingest or residual effect.
